(19) United States
(12) Patent Application Publication
(10) Pub. No.: US 2026/0363821 A1
(43) Pub. Date: Nov. 19, 2026

(54) ENGAGER TEMPLATES

(71) Applicants: Matthew KOSSOL, Round Rock, TX (US); Institut Straumann AG, Basel (CH)

(72) Inventors: Matthew Kossol, Round Rock, TX (US); Alain Hedinger, Basel (CH); Jacky Yu, Round Rock, TX (US); Maria Celeste Espina, Round Rock, TX (US)

(73) Assignee: Institut Straumann AG, Basel (CH)

(21) Appl. No.: 19/514,995

(22) PCT Filed: Aug. 29, 2024
(86) PCT No.: PCT/IB2024/058428

§ 371 Date: Feb. 27, 2026

Related U.S. Application Data
(60) Provisional application No. 63/579,574, filed on Aug. 30, 2023.

(51) Int. Cl. A61C 5/80

(52) U.S. Cl. CPC A61C 5/80

(57) ABSTRACT

The present disclosure discusses engager templates and the use of engager templates to bond engagers or other devices to a patient's teeth. An engager template is a dental appliance conformal to one or more teeth of a patient that includes a polymeric sheet composition with at least one layer. The polymeric sheet has a thickness between about 0.2 mm-0.5 mm and an elastic modulus between about 150,000 psi-300,000 psi. The engager template also includes at least one concave portion on an inner surface that is at least partially conformal to the patient's teeth. The concave portion is shaped to receive a composite material prior to positioning over the patient's teeth.

### CROSS-REFERENCE TO RELATED APPLICATION

This application claims priority to U.S. Provisional Application Ser. No. 63/579,574 entitled “ENGAGER TEMPLATES” filed Aug. 30, 2023, which is incorporated herein by reference in its entirety.

### FIELD OF THE TECHNOLOGY

The present technology relates to dental appliance manufacturing techniques. More specifically, this technology relates to techniques for manufacturing and using engager templates.

### BACKGROUND

Orthodontic aligners are appliances intended to make a series of discrete tooth position corrections aimed at aligning the teeth correctly. Aligners have many advantages over traditional bracket/wire braces for orthodontic treatment. For example, aligners are often transparent or semi-transparent, more comfortable than wire braces, and are removable for cleaning and for eating. The manufacture of aligners traditionally begins with generating a digital model of the patient's teeth, either by scanning the patient's teeth, or by making a dental impression of the patient's teeth and then scanning the impression. Once a digital model of the patient's teeth has been acquired, physical dental models can be fabricated (e.g. using 3D printing techniques) to provide a positive model of the teeth.

When an intra-oral scanning device (IOS device) is used to scan a patient's teeth, three-dimensional computer aided design (CAD) representations can be imported by custom software. The custom software allows the operator, such as a dental technician or dentist, to move individual teeth in specific and discrete movements and in a number of stages according to a treatment plan to achieve the final dental arch of aligned teeth.

For each stage of a patient's treatment plan, a 3D printed model of the dental arch is fabricated, and a polymer sheet can be thermoformed over the top of the 3D printed arch model to form the clear aligner.

The thermoformed part is then marked with part identification. The marked and thermoformed part is then cut by one of several methods so that the aligner that goes to the customer can be separated from the excess aligner material.

The aligner is then polished to remove burrs and sharp edges, inspected, and then packaged to be shipped to the patient's orthodontist, or directly to the patient. In order to provide more targeted forces to individual teeth various engagers or attachments may be secured to a patient's teeth that can interact with cavities or features of an aligner. Bonding or securing these engagers to a patient's teeth present a number of non-trivial challenges.

### SUMMARY

The present technology relates to techniques for manufacturing and using engager templates. According to one aspect of the present disclosure, a dental appliance is disclosed that is conformal to one or more teeth of a patient. The dental appliance includes a polymeric sheet composition having at least one layer with a thickness between about 0.2 mm-0.5 mm, and an elastic modulus between about 150,000 psi-300,000 psi. The dental appliance also includes at least one concave portion on an inner surface of the appliance conformal to the one or more teeth of the patient, where the concave portion is shaped to receive a composite material prior to positioning over the patient's teeth.

In some embodiments, the polymeric sheet composition includes a co-polyester having an elastic modulus between about 150,000 psi-300,000 psi; 160,000 psi-290,000 psi; 170,000 psi-280,000 psi; 160,000 psi-270,000 psi; 170,000 psi-260,000 psi; 180,000 psi-250,000 psi; 190,000 psi-230,000 psi; 195,000 psi-225,000 psi; 200,000 psi-220,000 psi; 205,000 psi-220,000 psi; or 215,000 psi-220,000 psi.

In some embodiments, the polymeric sheet composition includes a co-polyester having an elastic modulus between about 180,000 psi-220,000 psi; 185,000 psi-215,000 psi; 190,000 psi-210,000 psi; or 195,000 psi-205,000 psi.

In some embodiments, the dental appliance also includes a trimline extending between about-1 mm to 4.0 mm beyond a zenith of a gumline of a tooth.

In some embodiments, the dental appliance also includes a trimline extending between about 0 mm-2.0 mm beyond a zenith of a gumline of a tooth.

In some embodiments, the polymeric sheet composition includes a co-polyester having a thickness between about 0.25 mm-0.45 mm, 0.3 mm-0.4 mm, 0.35 mm-0.4 mm, or 0.34 mm-0.42 mm.

In some embodiments, the polymeric sheet composition has a pull-off force between a cured dental composite material of less than 22 Newtons (i.e., 22 N).

In some embodiments, the polymeric sheet composition has a pull-off force between a cured dental composite material between 5 N-22 N, 5 N-20 N, 5 N-15 N, 5 N-10 N, 1 N-10 N, 2 N-10 N, 3 N-10 N, or 4 N-10 N.

In some embodiments, the polymeric sheet composition comprises a co-polyester.

According to another aspect, the present disclosure relates to a method of bonding one or more engagers to a patient's teeth. The method includes depositing a composite material within at least one concave portion on an inner surface of a dental appliance. The inner surface of the dental appliance is conformal to one or more teeth of a patient. The method also includes positioning the engager template over one or more teeth of the patient; curing the composite material to form a cured composite engager bonded to a tooth of the patient; and removing the engager template from the teeth of the patient. The dental appliance includes a polymeric sheet composition comprising at least one layer having a thickness between about 0.2 mm-0.5 mm, and an elastic modulus between about 150,000 psi-300,000 psi.

In some embodiments, the polymeric sheet composition includes a co-polyester having an elastic modulus between about 150,000 psi-300,000 psi; 160,000 psi-290,000 psi; 170,000 psi-280,000 psi; 160,000 psi-270,000 psi; 170,000 psi-260,000 psi; 180,000 psi-250,000 psi; 190,000 psi-230,000 psi; 195,000 psi-225,000 psi; 200,000 psi-220,000 psi; 205,000 psi-220,000 psi; or 215,000 psi-220,000 psi.

In some embodiments, the polymeric sheet composition includes a co-polyester having an elastic modulus between about 180,000 psi-220,000 psi; 185,000 psi-215,000 psi; 190,000 psi-210,000 psi; or 195,000 psi-205,000 psi.

In some embodiments, the dental appliance includes a trimline extending between about-1.0 mm to 4.0 mm beyond a zenith of a gumline of a tooth.

In some embodiments, the dental appliance includes a trimline extending between about 0 mm-2.0 mm beyond a zenith of a tooth of a gumline.

In some embodiments, the polymeric sheet composition includes a co-polyester having a thickness between about 0.25 mm-0.45 mm, 0.3 mm-0.4 mm, 0.35 mm-0.4 mm, or 0.34 mm-0.42 mm.

In some embodiments, the polymeric sheet composition has a pull-off force between a cured dental composite material of less than 22 Newtons (i.e., 22 N).

In some embodiments, the polymeric sheet composition has a pull-off force between a cured dental composite material between 5 N-22 N, 5 N-20 N, 5 N-15 N, 5 N-10 N, 1 N-10 N, 2 N-10 N, 3 N-10 N, or 4 N-10 N.

In some embodiments, the polymeric sheet composition comprises a co-polyester.

### BRIEF DESCRIPTION OF THE DRAWINGS

The technology will be more fully understood from the following detailed description taken in conjunction with the accompanying drawings, in which:

FIG. 1 shows an example engager template for bonding an engager to a patient's teeth, according to an embodiment of the present disclosure.

FIG. 2 shows an example of an engager template placed over a patient's upper teeth, according to an embodiment of the present disclosure.

FIG. 3 shows a graph of adhesion characteristics of various engager template materials, according to embodiments of the present disclosure.

FIG. 4 shows a graph of adhesion characteristics of various composite materials, according to embodiments of the present disclosure.

FIG. 5 shows a graph of an adhesion test of various engager template and composite materials, according to embodiments of the present disclosure.

FIG. 6 shows an example engager template trimline, according to an embodiment of the present disclosure.

FIG. 7 depicts a flow diagram of a method for bonding an engager to a patient's teeth, according to embodiments of the present disclosure.

### DETAILED DESCRIPTION

The present disclosure relates to techniques for bonding engagers or other devices to a patient's teeth using an engager template, and materials and designs for such engager templates. In order to apply more precise forces on teeth during an orthodontic treatment, engagers or other features can be bonded to a patient's teeth. These engagers are often formed of a composite material that is cured onto a particular portion of a patient's teeth to provide an anchor point that an aligner can interact with. These engagers result in protrusions that extend from a patient's teeth and can be formed in various different shapes and sizes. Often these engagers are made of a composite material that substantially matches the color of the patient's teeth so that they are less noticeable. The engagers can fit within corresponding cavities or concave portions on an inner surface of a clear aligner (the surface of the aligner that contacts the patient's teeth).

Engagers can be bonded to a patient's teeth using an engager template, which is a transparent or semitransparent dental appliance that is shaped to fit over a patient's teeth and includes a concave portion that is sized and shaped to match the desired geometry of the engager. Since this engager template is not intended to move a patient's teeth, it's material properties and design can be distinct from a clear aligner.

To bond an engager to a patient's tooth, the engager template can first be placed over the patient's teeth to confirm a proper fit and that the concave portion(s) of the engager template matches the desired final placement of the engager(s). Once the engager is confirmed to fit properly, the location of all engagers can be identified on a patient's teeth. The engager template can then be removed, and the patient's tooth or teeth can be etched and rinsed in the area where the engager will bond to the tooth.

Once the patient's tooth has been etched and rinsed in the area where the engager will bond to the tooth, the engager cavity on the interior surface of the engager template can be filled with a composite. In some embodiments, it may be desirable to apply a light coat of petroleum jelly, or some other lubricant, to the engager cavity to prevent bonding of the composite with the engager template material. In some embodiments, the engager cavity is first filled with a paste-type compound about two-thirds full, and then the remaining third of the engager cavity is filled with a flowable composite. As will be appreciated, various different types of composite materials can be used in this process to create engagers. The techniques described herein can be implemented with any suitable flowable or paste compounds, or any combination of the two.

A bonding agent can also be applied and cured to the etched portion of the patient's tooth before placing the engager template back over the teeth. After placing the engager template back over the patient's teeth with the composite material contained within the engager cavity, the composite material can be cured to form a solid engager that is bonded to the tooth. Once the composite material is cured, the engager template can be removed from the patient's teeth and any excess material around the engager can be removed with a scaler. Now that the physical engager has been placed onto the desired tooth, the fit of the dental aligner can be checked. Various different types of engagers with different geometries can be applied in this way, and multiple engagers can be applied at the same time on different teeth.

During this process of applying engagers, a number of challenges for providers can arise. In some cases, providers can have difficulty removing the engager templates after bonding the engagers to the teeth. A number of factors can contribute to these challenges including, but not limited to, the flexibility or rigidity of the engager template material, the tendency of the engager template material improperly bond with the composite material, or the dimensions of the engager template making it more challenging than necessary to remove.

The engager templates disclosed herein may be made of a polymeric material, such as a thin thermoformable material. In some cases, the engager templates are manufactured by thermoforming a polymeric material around a dental model of a patient's teeth, where the dental model includes protrusions that match the final geometry and position of the engagers. The thickness of the polymeric material should be of sufficient thickness to thermoform around a dental model.

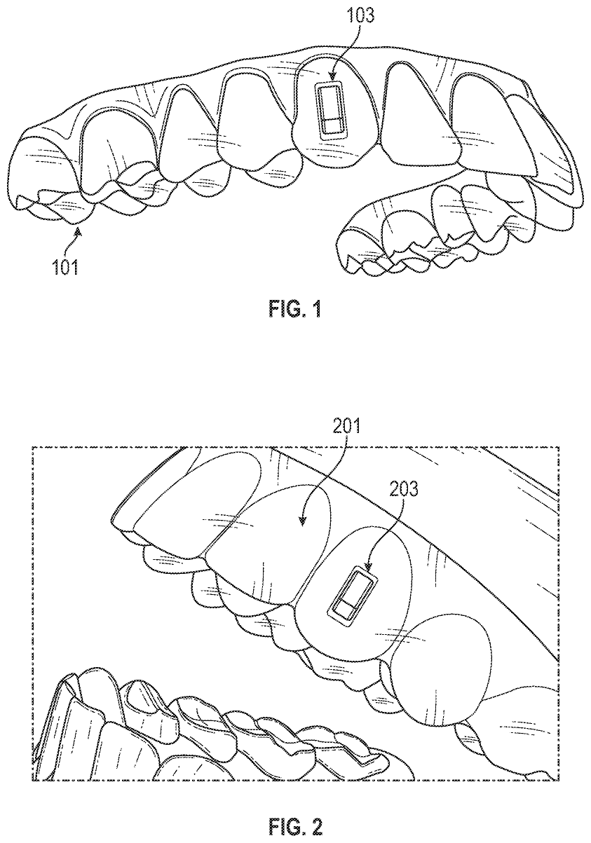

FIG. 1 shows an example engager template 101 for bonding an engager to a patient's teeth, according to an embodiment of the present disclosure. In this example embodiment, the engager template 101 is in the form of a transparent thermoformed dental appliance and includes a concave engager cavity 103 formed in an interior surface of the engager template 101 (i.e., the surface of the engager template that contact the patient's teeth). Although only one engager cavity 103 is shown in this embodiment, multiple engager cavities of varying geometries and in different positions can be included within a single engager template in order to bond different engagers to different teeth.

According to one embodiment, the engager template 101 can be formed from a polymeric sheet, such as a co-polyester, that is thermoformed over a positive model of a patient's dentition. In alternative embodiments, the engager template 101 could be formed from low density polyethylene, polyurethane, or ethylene vinyl acetate. The model of the patient's dentition can be fabricated, in some embodiments, using 3D printing or other additive manufacturing processes, and can include a protrusion on one or more teeth corresponding to the desired engagers that are to be bonded to the patient's teeth. This physical model of the patient's teeth with the engager can be modeled and designed using various software products based on digital scans of a patient's teeth. During the treatment planning process, a technician or dental provider can manipulate a 3D digital model of the patient's dentition and position virtual engagers on various teeth. This digital model can then be used to manufacture the physical model of the patient's dentition that can be used to thermoform the engager template 101.

FIG. 2 shows an example of an engager template 201 placed over a patient's upper teeth, according to an embodiment of the present disclosure. In this embodiment, the patient's tooth receiving the engager would have already been treated, as discussed above, and the composite material placed within the engager cavity 203. Once the engager template 201 is placed over the patient's teeth, the composite material within the engager cavity 203 can be cured, and then the engager template 201 can be removed to leave behind a solid engager bonded to the patient's tooth.

### Material Properties

Because the engager template is used to bond an engager to a patient's teeth, rather than to move teeth during a step of an orthodontic treatment plan, the material properties of the engager template can be distinct from the material properties of a transparent aligner.

In order to examine the efficacy of various engager template materials and designs, a number of experiments and tests were performed and are discussed below. In these experiments, engager template materials having different thicknesses, flexibility, and rigidity properties were tested to determine ease of application and removal. Different engager template materials were also tested with different composite materials to determine material adhesion properties. Different engager template trimlines were also tested to determine ease of application of the engagers and removal of the engager templates.

In one example, it was discovered that a more flexible material than an aligner material was an improvement for attaching engagers effectively and removing the engager template from the patient's mouth.

In one specific embodiment, a co-polyester having suitable flexibility and low composite adhesion properties included an amorphous co-polyester having a transverse direction (TD) elastic modulus of about 200,000 psi (about 1,380 MPa), and a machine direction (MD) elastic modulus of about 210,000 psi (about 1,460 MPa), when tested according to the ASTM D882 test method with a test thickness of 9.8 mil.

The term “elastic modulus” is used as a measurement of the resistance of a material to elastic deformation under load. The elastic modulus is defined as the ratio of the force exerted upon a material to the resulting deformation. The term “flexibility” describes the ability of a material to deform elastically and return to its original shape when force is removed. Thus, a stiffer material would have a higher elastic modulus (i.e., a higher force is required to cause deformation), while a more flexible material would have a lower elastic modulus (i.e., a lesser force is required to cause deformation). Material thickness can also impact flexibility such that a thicker piece of the same material can be less flexible than a thinner piece.

In other embodiments, a thermoplastic can be used having an elastic modulus between about 150,000 psi-300,000 psi; 160,000 psi-290,000 psi; 170,000 psi-280,000 psi; 160,000 psi-270,000 psi; 170,000 psi-260,000 psi; 180,000 psi-250,000 psi; 190,000 psi-230,000 psi; 195,000 psi-225,000 psi; 200,000 psi-220,000 psi; 205,000 psi-220,000 psi; or 215,000 psi-220,000 psi.

In one specific embodiment, a co-polyester having suitable flexibility and low composite adhesion properties included a TD tensile strength at yield of about 5,800 psi (about 39.9 MPa), and a MD tensile strength at yield of about 5,950 psi (about 41 MPa), when tested according to the ASTM D882 test method with a test thickness of 9.8 mil.

In other embodiments, a thermoplastic can be used having tensile strength between about 5,500 psi-6,300 psi; 5,600 psi-6,200 psi; 5,700 psi-6,100 psi; or 5,800 psi-6,000 psi.

In other embodiments, a thermoplastic can be used having tensile strength between about 5,000 psi-11,000 psi; 5,500 psi-10,500 psi; 6,000 psi-10,000 psi; 6,500 psi-9,500 psi; 7,000 psi-9,000 psi; or 7,500 psi-8,5000 psi.

In other embodiments, a thermoplastic can be used having yield stress between about 4,000 psi-9,000 psi; 4,500 psi-8,500 psi; 5,000 psi-8,000 psi; 5,500 psi-7,500 psi; 5,500 psi-7,000 psi; 5,500 psi-6,500 psi; or 5,500 psi-6,000 psi.

In other embodiments, a thermoplastic can be used having an elongation at break between about 110%-130%, or 115%-125%.

In one specific embodiment, a co-polyester having suitable flexibility and low composite adhesion properties included a density of about 1.2 g/cm³, when tested according to the ASTM D1505 test method.

In other embodiments, a thermoplastic can be used having a density between about 0.9 g/cm³-1.3 g/cm³; 1.0 g/cm³-1.25 g/cm³; 1.05 g/cm³-1.2 g/cm³; 1.1 g/cm³-1.2 g/cm³; or 1.15 g/cm³-1.2 g/cm³.

In one specific embodiment, a co-polyester having suitable flexibility and low composite adhesion properties included a glass transition temperature of about 230 °F (100 °C). In other embodiments, a thermoplastic can be used having a glass transition temperature between about 200 °F-260 °F, 210 °F-250 °F, or 220 °F-240 °F.

TABLE 1

| Attribute | Test Method \| Tools | Acceptance Criteria |
|---|---|---|
| Appearance | Visual Inspection / | Free of bubbles or |
| | Observation | inclusions |
| Material | FTIR SOP 04-03-26 | Compare to standard, |
| Composition | | match > 99% |
| Optical | Color Measurement SOP | AB value < 1 unit |
| | 04-03-01 | |
| Tensile Strength | ASTM D638, SOP | 4,000-11,000 |
| (PSI) | 04-03-36 | |
| Yield Stress (PSI) | | 4,000-10,000 |
| Elongation @ Break | | 40-250 |
| (%) | | |
| Elongation @ Yield | | 4-8 |
| (%) | | |
| Elastic Modulus | | 150,000-300,000 |
| (PSI) | | |

Table 1 shows a set of acceptance criteria for a number of material parameters for a suitable co-polyester having a thickness of about 0.38 mm, according to an embodiment of the present disclosure. In alternative embodiments, materials of different thicknesses can be used and may have slightly different material parameters due to the increased thickness, or the same material parameters as those shown in Table 1.

### Material Thickness

In one embodiment, a co-polyester sheet having a thickness at or less than 0.5 mm resulted in a more flexible engager template after thermoforming and a low tendency for the engager template to attach to the composite material. Possible thickness ranges can include, for example, between 0.2 mm-0.5 mm, 0.25 mm-0.45 mm, 0.3 mm-0.4 mm, 0.35 mm-0.4 mm, or 0.34 mm-0.42 mm. In one specific embodiment, a co-polyester sheet having a thickness of about 0.38 mm before thermoforming resulted in a suitably flexible engager template and a low tendency for the engager template to attach to the composite material.

TABLE 2

| | Test Method \| | |
|---|---|---|
| Type, Target | Tools | Acceptance Criteria |
| Product Thickness, 0.38 mm | Calipers | 0.34 mm to 0.42 mm |
| Roll Width, 137 mm | Calipers | 135.4 to 138.6 mm |
| Sheet Width, 125 mm | Calipers | 122.5 mm to 126.8 mm |

Table 2 provides a set of acceptance criteria for physical dimensions for a suitable roll of co-polyester having a nominal thickness of about 0.38 mm, according to one specific embodiment of the present disclosure. In some embodiments, a material thicker than 0.38 mm can be used (e.g., at about 0.5 mm). In such cases, a slightly thicker material can result in decreased flexibility.

### Material Adhesion

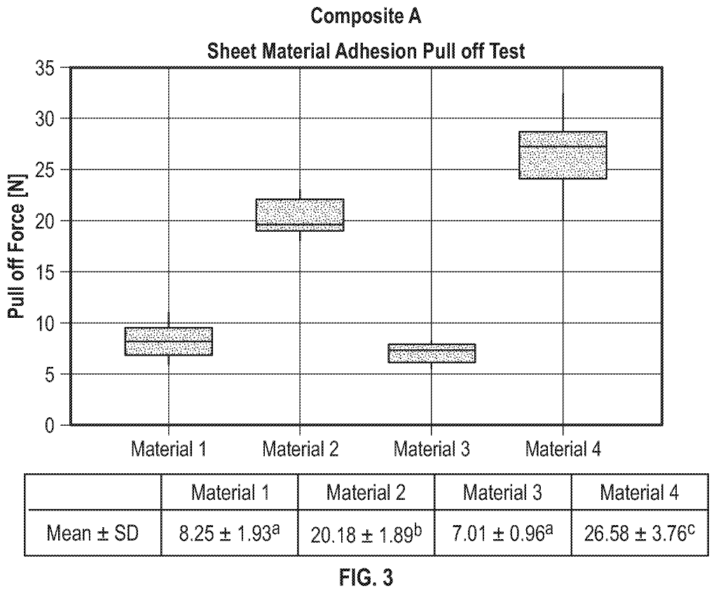

FIG. 3 shows a graph of adhesion characteristics of various engager template materials, according to embodiments of the present disclosure. In the experiment illustrated in FIG. 3, a dental composite material identified as Composite A was cured to sheets of engager template material candidates identified as Material 1, Material 2, Material 3, and Material 4. A mechanical tester was used to measure the force required to decouple the composite from the engager template material.

As can be seen in FIG. 3, Materials 1-3 demonstrated superior adhesion characteristics (i.e., they adhered less to the composite material and less force was required to separate them) compared with Material 4. Each of these tests was performed without using petroleum jelly or any other lubricant between the test material and the composite material.

In one embodiment, a suitable thermoplastic material for use with the engager templates disclosed herein can have a material adhesion pull-off force of below 22 Newtons (i.e., 22 N). In other embodiments, a suitable thermoplastic material for use with the engager templates disclosed herein can have a material adhesion pull-off force between about 5 N-22 N, 5 N-20 N, 5 N-15 N, 5 N-10 N, 1 N-10 N, 2 N-10 N, 3 N-10 N, or 4 N-10 N.

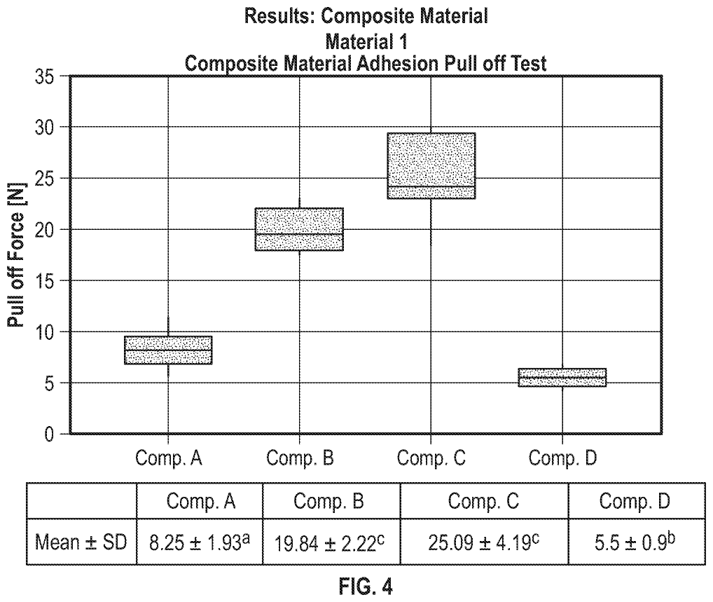

FIG. 4 shows a graph of adhesion characteristics of various composite materials, according to embodiments of the present disclosure. In the experiment illustrated in FIG. 4, Material 1 from FIG. 3, which included a co-polyester material with favorable adhesion characteristics and other material properties within favorable ranges discussed above, was tested against a number of different dental composite materials. These various dental composites identified as Comp. A, Comp. B, Comp. C, and Comp. D were cured to sheets of Material 1 and a mechanical tester was used to measure the force required to decouple the composite from Material 1. As can be seen in FIG. 4, Material 1 performed well and had suitably low material adhesion to the composites, and in particular had low material adhesion with Comp. A and Comp. D.

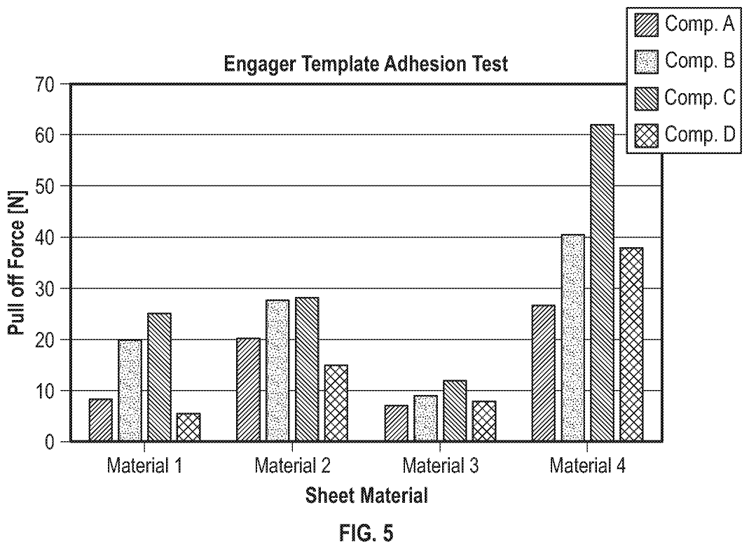

FIG. 5 shows a graph of an adhesion test of various engager template and composite materials, according to embodiments of the present disclosure. As illustrated in FIG. 5, Materials 1-3 performed better and adhered less to each composite tested compared against Material 4. Notably, Material 1, which included a co-polyester material with other material properties within favorable ranges discussed above performed significantly better than Material 4 and had the lowest pull-off force for Composite D.

### Engager Template Trimline

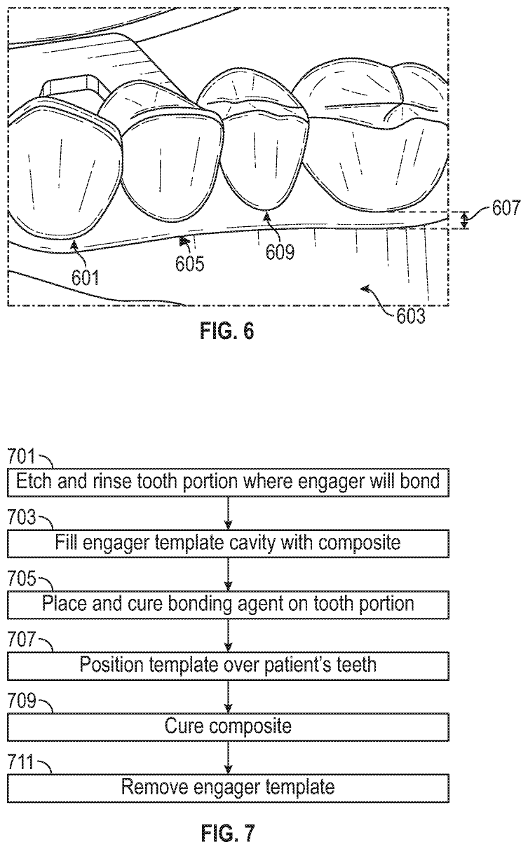

FIG. 6 shows an example engager template trimline, according to an embodiment of the present disclosure. In this example embodiment, an engager template 601 has been thermoformed over a model of a patient's dentition 603. This engager template 601 has been trimmed along a trimline 605 to remove excess thermoplastic material.

Because the engager template is not intended to move teeth, the trimline of the engager template does not need to be the same as the trimline for the future aligner that a patient will use during a treatment plan. In some embodiments, a higher or lower trimline can provide increased flexibility, or reduce unnecessary retention and rigidity and therefore help prevent engagers from being pulled off when removing the engager template after the curing process.

In the example shown in FIG. 6, the trimline 605 can be defined by the distance 607 which the engager template 601 extends beyond the zenith 609 of the gumline of a tooth of the patient. In one example embodiment, a trimline that extends a distance 607 between about 0-2 mm past the zenith 609 of the gumline of the tooth resulted in a better fit for placing engagers without significantly sacrificing ease of removal of the template. In some embodiments, a suitable trimline can extend a distance 607 between about −1.0 mm to 4.0 mm; −0.5 mm to 4.0 mm; 0 mm to 4.0 mm; 0 mm to 3.5 mm; 0 mm to 2.5 mm; 0 mm to 2.0 mm; 0 mm to 1.5 mm; 0 mm to 1.0 mm; or 0 mm to 0.5 mm past the zenith 609 of the gumline of the tooth. In examples featuring a negative value for distance 607, the trimline 605 is positioned such that the engager template 601 ends before the zenith 609, i.e., the trimline 605 is before the zenith 609, such that the zenith is not covered by the engager template 601.

In some embodiments, the trimline of an engager template can vary across the different teeth of the patient. Depending on the different sizes of a patient's teeth, tooth position, and many other factors, it can be challenging to form a smooth trimline along an entire engager template that is cut at the same distance with respect to the zenith of the gumline of each and every tooth in a patient's dentition. Thus, the trimline of a single engager template can be measured at different values with respect to different teeth.

According to some embodiments, the trimline can vary within an engager template within certain values, such as those ranges disclosed above. In one preferred embodiment, the trimline is preferably between about 0 mm-2 mm when measured along all or most of the teeth within a patient's dentition.

In some cases, a trimline can also have a minimum distance with respect to the position of the engager itself. For example, the engager template can have a trimline that ensures at least 1 mm of distance between the trimline and the closest portion of the engager that is being bonded to the tooth. This minimum trimline distance can ensure that there is sufficient material in the engager template to accurately place engagers.

### Methodology

FIG. 7 depicts a flow diagram of a method for bonding an engager to a patient's teeth, according to embodiments of the present disclosure. In this example embodiment, at 701 the method begins by etching and rinsing a portion of the tooth where an engager will be placed. In some cases, additional steps could be performed prior to 701, such as testing proper fit of the engager template, etc. Depending on the type of composite being used, different preparation steps may be involved as well.

At 703, the engager template cavity is filled with a composite material. In some alternative embodiments, it may be desirable to apply a light coat of petroleum jelly, or some other lubricant, to the engager cavity to prevent bonding of the composite with the engager template material. In some embodiments, the engager cavity is first filled with a paste-type compound, and then the remaining portion of the engager cavity is filled with a flowable composite. As will be appreciated, various different types of composite materials can be used in this process to create engagers.

At 705, a bonding agent can be applied and cured to the etched portion of the patient's tooth before placing the engager template over the teeth at 707. As discussed above, various material characteristics, thicknesses, and trimlines of the engager template can contribute to the ease of placing the engager template over the patient's teeth, and thus accurately placing the engager in the desired location.

In some embodiments, the acid etching at 701 and the bonding agent application at 705 can be optional operations.

After placing the engager template over the patient's teeth with the composite material contained within the engager cavity, the composite material can be cured at 709 to form a solid engager that is bonded to the tooth.

At 711, the engager template can be removed from the patient's teeth leaving behind the engager bonded to the tooth. Various material properties and design choices of the engager template, such as material adhesion characteristics, flexibility, thickness, trimline, etc. can contribute to the ability to easily remove the engager template without damaging or removing the bonded engager from the patient's tooth, as discussed above. In some embodiments, any excess material around the engager can be removed with a scaler.

One skilled in the art will be appreciated that additional processing steps, or fewer steps could be performed in order to apply engagers using the engager templates disclosed herein.

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

1. A dental appliance conformal to one or more teeth, comprising:
a polymeric sheet composition comprising at least one layer having a thickness between about 0.2 mm-0.5 mm, and an elastic modulus between about 150,000 psi-300,000 psi; and
at least one concave portion on an inner surface of the appliance at least partially conformal to the one or more teeth of a patient, the at least one concave portion shaped to receive a composite material prior to positioning over the patient's teeth.

2. The dental appliance of claim 1, wherein the polymeric sheet composition comprises a co-polyester.

3. The dental appliance of claim 2, wherein the polymeric sheet composition includes a co-polyester having an elastic modulus between about 150,000 psi to 300,000 psi.

4. The dental appliance of claim 2, wherein the polymeric sheet composition includes a co-polyester having an elastic modulus between about 180,000 psi to 220,000 psi.

5. The dental appliance of claim 1, further comprising a trimline extending between about −1.0 mm to 4.0 mm beyond a zenith of a gumline of a tooth.

6. The dental appliance of claim 1, further comprising a trimline extending between about 0 mm to 2.0 mm beyond a zenith of a gumline of a tooth.

7. The dental appliance of claim 1, wherein the polymeric sheet composition includes a co-polyester having a thickness between about 0.25 mm to 0.45 mm.

8. The dental appliance of claim 1, wherein the polymeric sheet composition has a pull-off force between a cured dental composite material of less than 22 N.

9. The dental appliance of claim 1, wherein the polymeric sheet composition has a pull-off force between a cured dental composite material between 5 N-22 N.

10. A method of bonding one or more engagers to a patient's teeth, comprising:
depositing a composite material within at least one concave portion on an inner surface of a dental appliance, the inner surface of the dental appliance at least partially conformal to one or more teeth of a patient,
positioning the engager template over one or more teeth of the patient;
curing the composite material to form a cured composite engager bonded to at least one tooth of the patient; and
removing the engager template from the one or more teeth of the patient,
wherein the dental appliance includes a polymeric sheet composition comprising at least one layer having a thickness between about 0.2 mm-0.5 mm, and an elastic modulus between about 150,000 psi-300,000 psi.

11. The method of claim 10, wherein the polymeric sheet composition comprises a co-polyester.

12. The method of claim 11, wherein the polymeric sheet composition includes a co-polyester having an elastic modulus between about 150,000 psi-300,000 psi.

13. The method of claim 11, wherein the polymeric sheet composition includes a co-polyester having an elastic modulus between about 180,000 psi-220,000 psi.

14. The method of claim 10, wherein the dental appliance includes a trimline extending between about-1 mm-4.0 mm beyond a zenith of a gumline of a tooth.

15. The method of claim 10, wherein the dental appliance includes a trimline extending between about 0 mm-2.0 mm beyond a zenith of a tooth of a gumline.

16. The method of claim 10, wherein the polymeric sheet composition includes a co-polyester having a thickness between about 0.25 mm-0.45 mm.

17. The method claim 10, wherein the polymeric sheet composition has a pull-off force between a cured dental composite material of less than 22 N.

18. The method of claim 10, wherein the polymeric sheet composition has a pull-off force between a cured dental composite material between 5 N-22 N.
